(19) United States
(12) Patent Application Publication
(10) Pub. No.: US 2014/0344449 A1
(43) Pub. Date: Nov. 20, 2014

(54) IP ADDRESS ALLOCATION FOR WI-FI CLIENTS

(71) Applicant: Benu Networks, Inc., Billerica, MA (US)

(72) Inventors: David F. CALLAN, Swampscott, MA (US); Rajendar DUGGAL, Lincoln, MA (US); Rajat GHAI, Sandwich, MA (US); Ramesh GUPTA, Acton, MA (US); Tapas RAY, Minneapolis, MN (US); Swarup SAHOO, Acton, MA (US); Anil SANGAHVI, Westford, MA (US)

(73) Assignee: Benu Networks, Inc., Billerica, MA (US)

(21) Appl. No.: 14/280,918

(22) Filed: May 19, 2014

Related U.S. Application Data
(60) Provisional application No. 61/824,802, filed on May 17, 2013.

(51) Int. Cl. H04L 29/12

(52) U.S. Cl. CPC H04L 61/203
USPC 709/224

(57) ABSTRACT

Computerized systems and computerized methods are provided for internet protocol (IP) address allocation for Wi-Fi clients in a manner that avoids assigning a public IP address to a device if the device is not first activated to use services provided by the network. A private IP network address is allocated to a device, wherein the private IP network address is only valid for a predetermined period, and only allows the device to activate itself with the network instead of providing the device full access to the network. The device is monitored during the predetermined period so that if the device is activated to use the network during the predetermined period, the computing device assigns a public IP address to the device so that the device can access a full set of services provided by the network.

### RELATED APPLICATIONS

This application relates to and claims priority under 35 U.S.C. §119(e) to U.S. provisional patent application No. 61/824,802, filed on May 17, 2013, which is hereby incorporated herein by reference in its entirety.

### FIELD

The subject matter disclosed in this application generally relates to computing and communication systems and, more specifically, to internet protocol (IP) address allocation for Wi-Fi clients.

### BACKGROUND

Computing devices (such as laptops, personal computers, tablets, cell phones, etc.) can be configured to communicate over wired and/or wireless networks. For networks that use the Internet Protocol for communication, for example, internet protocol (IP) addresses are a numerical labels assigned to each device participating in the network. The IP address can be used to identify the host or network interface, and can also be used for location addressing of transmissions among the devices.

Typically a computing device needs to be assigned an IP address before it can communicate with other devices in the network. IP addresses can be assigned to computing devices in different ways, such as assigning an IP address anew at the time of booting, assigning an IP address when the device is connected to (or comes into range) of the network, and/or permanently fixing the IP address by configuring the device's hardware or software. Permanently fixing an IP address is often referred to as using a static IP address. In contrast, in situations when the device's IP address is assigned newly each time (whether at boot, connection, etc.), this is often referred to as using a dynamic IP address.

IP addresses are often assigned dynamically on networks such as local area networks (LANs) and broadband networks by using the Dynamic Host Configuration Protocol (DHCP). Networks using DHCP can include a DHCP server that dynamically distributes IP addresses and other network configuration parameters. Dynamic IP addresses are often used because it avoids the administrative burden of assigning specific static addresses to each device on a network (since devices need unique IP addresses). It can also allow many devices to share limited address space on a network if only some of them will be online at a particular time. Dynamic IP configuration is often enabled in most current desktop operating systems, routers, and/or the like by default so that a user does not need to manually enter settings to connect to a network with a DHCP server. It is worth noting that DHCP is not the only technology used to assign IP addresses dynamically. Dialup and some broadband networks, for example, use dynamic address features of the Point-to-Point Protocol.

As mentioned above, when a wireless device comes into range of a wireless access point or router (such as for Wi-Fi networks that implement the 802.11 wireless protocol), an IP address is assigned to the device to connect the device to the wireless network. Once the device falls out of range from the router, the connection is terminated and the IP address can be re-assigned to other connecting devices. Such assignment can be problematic with migrant users that will automatically connect to the network (e.g., based on pre-configured parameters of the device) but that usually do not access any network services. Such automatic IP assignment to migrant devices may prevent these public IP address from being used by other devices that intend to access network services since there is usually a limited number of public IP addresses to assign to devices. For network service providers, migrant devices that tie up public IP address may lead to reservation of public IP addresses for non-revenue producing users/devices. Since there is usually a limited pool of routable IP addresses from which the IP addresses can be allocated, migrant users can detrimentally affect the use of the network by other users and in-turn affect the network service providers ability to provide a reliable network experience and to generate revenue, among other issues.

### SUMMARY

In accordance with the disclosed subject matter, systems and methods are described for internet protocol (IP) address allocation for Wi-Fi clients to efficiently allocate IP addresses to activated subscribers (e.g., authenticated and/or authorized subscribers) that intend to use the services provided by the network service provider.

Disclosed subject matter includes, in one aspect, a computerized method for allocating internet protocol (IP) addresses to devices in a manner that avoids assigning a public IP address to a device if the device is not first activated to use services provided by the network. The method includes allocating, by a computing device, a private IP network address to a device, wherein the private IP network address is only valid for a predetermined period, and only allows the device to activate itself with the network instead of providing the device full access to the network. The method includes monitoring, by the computing device, the device during the predetermined period so that if the device is activated to use the network during the predetermined period, the computing device assigns a public IP address to the device so that the device can access a full set of services provided by the network, or if the device is not activated to use the network during the predetermined period, the private IP address allocated to the device is reclaimed by the computing device so that the private IP address is no longer allocated to the device and can therefore be allocated to other devices.

Disclosed subject matter includes, in another aspect, a computing system configured to allocate internet protocol (IP) addresses to devices in a manner that avoids assigning a public IP address to a device if the device is not first activated to use services provided by the network. The system includes a database configured to store a set of private IP network addresses and a set of public IP network addresses, wherein each private IP network address from the set of private IP network addresses is only valid for a predetermined period, and only allows the device to activate itself with the network instead of providing the device full access to the network. The computing system includes a processor in communication with the database, and configured to run a module stored in memory that is configured to cause the processor to allocate a private IP network address from the set of private IP network addresses to a device. The module stored in memory is configured to monitor the device during the predetermined period so that if the device is activated to use the network during the predetermined period, the computing system assigns a public IP address from the set of public IP addresses to the device so that the device can access a full set of services provided by the network, or if the device is not activated to use the network during the predetermined period, the private IP address allocated to the device is reclaimed by the computing system so that the private IP address is no longer allocated to the device and can therefore be allocated to other devices.

Disclosed subject matter includes, in yet another aspect, a non-transitory computer readable medium. The non-transitory computer readable medium has executable instructions operable to cause an apparatus to allocate a private IP network address to a device, wherein the private IP network address is only valid for a predetermined period, and only allows the device to activate itself with the network instead of providing the device full access to the network. The executable instructions are operable to cause an apparatus to monitor the device during the predetermined period so that if the device is activated to use the network during the predetermined period, the apparatus assigns a public IP address to the device so that the device can access a full set of services provided by the network, or if the device is not activated to use the network during the predetermined period, the private IP address allocated to the device is reclaimed by the apparatus so that the private IP address is no longer allocated to the device and can therefore be allocated to other devices.

Various embodiments of the subject matter disclosed herein can provide one or more of the following capabilities. The techniques described herein can be used to reduce public IP address hold-up by migrant Wi-Fi subscribers. Private IP addresses can first be allocated to devices to allow the device to activate itself with the network for a limited duration. If the device fails to activate itself (e.g., via authentication), then the device is not assigned a public IP address. Since the public IP addresses are reserved only for subscribers that intend to use the network, the techniques described herein can help avoid the denial of service to subscribers (e.g., due to public IP address exhaustion). In some embodiments, by allocating public IP addresses only to subscribers who intend to use the network, the techniques an increase the network service provider's revenue stream and increase the service availability of the network.

These and other capabilities of embodiments of the disclosed subject matter will be more fully understood after a review of the following figures, detailed description, and claims.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings.

FIG. 1 illustrates a block diagram of a system for IP address allocation, according to some embodiments.

FIG. 2 illustrates an IP address table with a private IP address pool and a public IP address pool for IP address allocation, according to some embodiments.

FIG. 3 illustrates a computerized method for IP address allocation, according to some embodiments.

FIG. 4 illustrates a sequence for IP address translation, according to some embodiments.

FIGS. 5A and 5B illustrate a computerized method for translating an IP address for IP address allocation, according to some embodiments.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

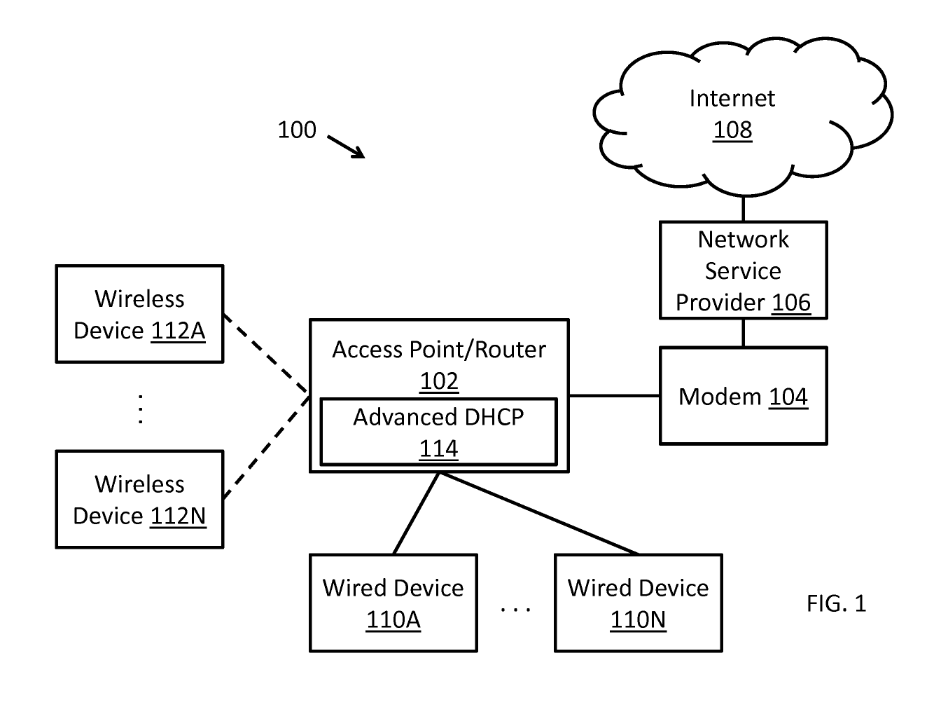

FIG. 1 illustrates a block diagram of a system 100 for IP address allocation, according to some embodiments. The system 100 includes an access point or router 102 (referred to herein generally as router 102), a modem 104, a network service provider 106, and the internet 108. The router 102 is in communication with the modem 104, the modem 104 is in communication with the network service provider 106, and the network service provider 106 is in communication with the internet 108. The router 102 is physically connected to wireless devices 110A through 110N (e.g., via Ethernet cables). The router 102 is wirelessly connected to wireless devices 112A through 112N, as indicated by the dotted lines between the router 102 and the wireless devices 112. The router 102 has an advanced IP address allocation mechanism, referred to herein as advanced DHCP 114.

Router 102 can include a processor (not shown) configured to implement the functionality described herein using computer executable instructions stored in a temporary and/or permanent non-transitory memory. The memory can be flash memory, a magnetic disk drive, an optical drive, a programmable read-only memory (PROM), a read-only memory (ROM), or any other memory or combination of memories. The processor can be a general purpose processor and/or can also be implemented using an application specific integrated circuit (ASIC), programmable logic array (PLA), field programmable gate array (FPGA), and/or any other integrated circuit. The router 102 can include a database that may also be flash memory, a magnetic disk drive, an optical drive, a programmable read-only memory (PROM), a read-only memory (ROM), or any other memory or combination of memories. The router 102 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs.

The modem 104 can be any standard modem configured to modulate/demodulate signals, such as a cable modem, DSL modem, and/or the like.

The network service provider 106 is a business or organization that sells bandwidth and/or internet access that can be used by wired devices 110 and/or wireless devices 112. Network service providers often provide a direct Internet backbone access, and often access to its network access points. Examples of network service providers include Internet service providers, telecommunications companies, data carriers, wireless communications providers, and cable television operators offering high-speed access to Internet 108.

The components of system 100 can include additional interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols, some of which may be non-transient.

While the techniques described herein describe in some embodiments using the techniques over a public Wi-Fi network, one of skill in the art can appreciate that the resulting network created can include a single network or combination of networks. For example, the network can include a local area network (LAN), a cellular network, a telephone network, a computer network, a private packet switching network, a line switching network, a wide area network (WAN), and/or any number of networks, including intranets and Internet 108. Such networks may be implemented with any number of hardware and software components, transmission media and network protocols. FIG. 1 shows the router 102 creating a single network among the wired devices 110 and the wireless devices 112; however, the network can include multiple interconnected networks listed above.

The advanced DHCP feature 114 of the router 102 implements the techniques described herein to allocate IP addresses for Wi-Fi clients (e.g., wired device 110 and wireless device 112) so that the Wi-Fi clients can access services provided by the network service provider 106 only after activating themselves with the network service provider. In some embodiments, the router 102 can be configured to first allocate an IP address from a private IP address pool to a subscriber (e.g., whether a migrant subscriber or not). Ultimately, if the subscriber is activated (e.g., authenticated and authorized), the router 102 can assign a public address to the subscriber for continued use of services provided by the network service provider.

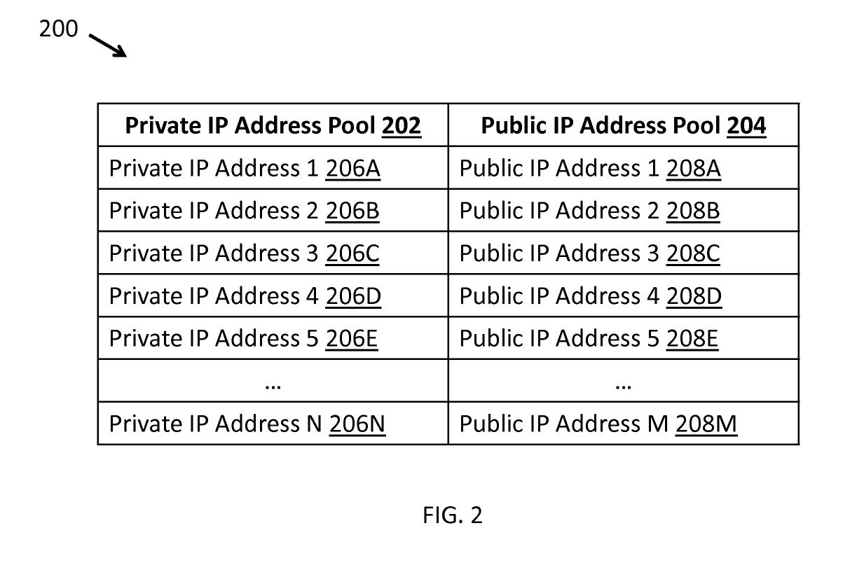

FIG. 2 illustrates an IP address table 200 with a private IP address pool 202 and a public IP address pool 204 for IP address allocation, according to some embodiments. The private IP address pool 202 includes private IP addresses 206A through 206N (collectively private IP addresses 206). The public IP address pool 204 includes public IP addresses 208A through 208M (collectively private IP addresses 208). In some embodiments, the number of private IP addresses (N) is less than the number of public IP addresses (M). The IP address table 200 can be stored in a database on the router 102.

The router can use private IP addresses 206 from the private IP address pool 202 to, for example, provide limited connection to a service provider network. For example, if the service provider network receives packets addressed from a private IP address 206, the service provider network can be configured to only allow certain services of the full set of services offered by the service provider network. In some embodiments, the service provider network can provide limited services such as activation services (e.g., authentication services and/or authorization services) to determine whether to allow the requesting device full access to the service provider network.

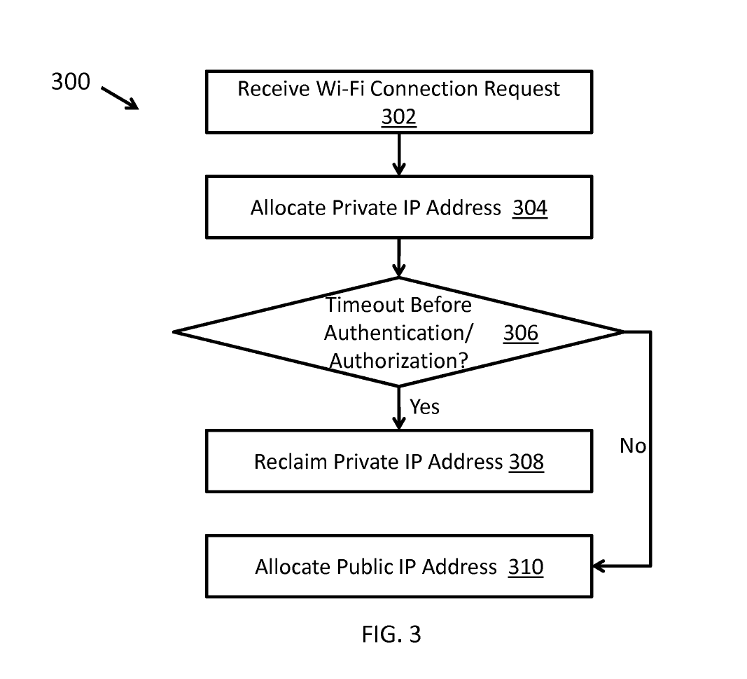

The private IP addresses 206 can be configured such that they are only valid for a limited duration. FIG. 3 illustrates a computerized method 300 for IP address allocation (e.g., performed using advanced DHCP), according to some embodiments. At step 302, the router (e.g., router 102) receives a Wi-Fi connection request from a device (e.g., wireless device 112). At step 304, the router allocates a private IP address 304 to the device. At step 306, the router monitors the device for a predetermined period (e.g., by starting a timer). If the device does not perform the activation steps that are required (e.g., by the service provider network) to be granted full access to the network within the predetermined period, the method 100 proceeds to step 308 and reclaims the private IP address 308 that was allocated to the device (e.g., therefore ending the device's session with the router). If the device performs the required steps within the predetermined period, then the method proceeds to step 310 and allocates a public IP address 310.

Referring to step 304, the device is assigned a private IP address 206 to allow the device to perform whatever requirements are determined by the service provider network in order to gain full access to the service provider network. For example, the service provider network may require that a device is authenticated before it is given full access to the service provider network. As another example, the service provider network may require that a device is authorized before it is given full access to the service provider network. In some embodiments, the service provider network may require that the devise is both authenticated and authorized. One of skill in the art can appreciate that there are any number of activation steps that may be required before providing a device access to the network.

Referring to step 306 and step 308, if the device stays dormant during the limited duration (e.g., does not satisfy the activation requirements to gain network access), the allocated IP address can be reclaimed by the router. In some embodiments, reclaiming the private IP address terminates the device's connection with the router such that the private IP address can be reassigned to another device.

Referring to step 310, if the subscriber is authenticated and authorized (e.g., by the service provider), the router can assign a public IP address from the public IP address pool to the device. In some embodiments, even if activated, the router can be configured to wait to assign a public IP address until the device requests access to network services (e.g., during the limited duration). By assigning a public IP address to the device, the device's session with the router can be maintained and extended to provide full access to the network.

In some embodiments, since communications were started with the device using the private IP address, the router may be configured to translate packets sent from the device to use the public IP address. For example, for traffic originating from that device, the router replaces the device's private IP address with the public IP address allocated to the device. Similarly, for traffic destined to that device the router can replace the public IP address with the private IP address. While some examples used herein perform the address replacement at the router, the techniques can be implemented in other devices, such as devices of the network service provider.

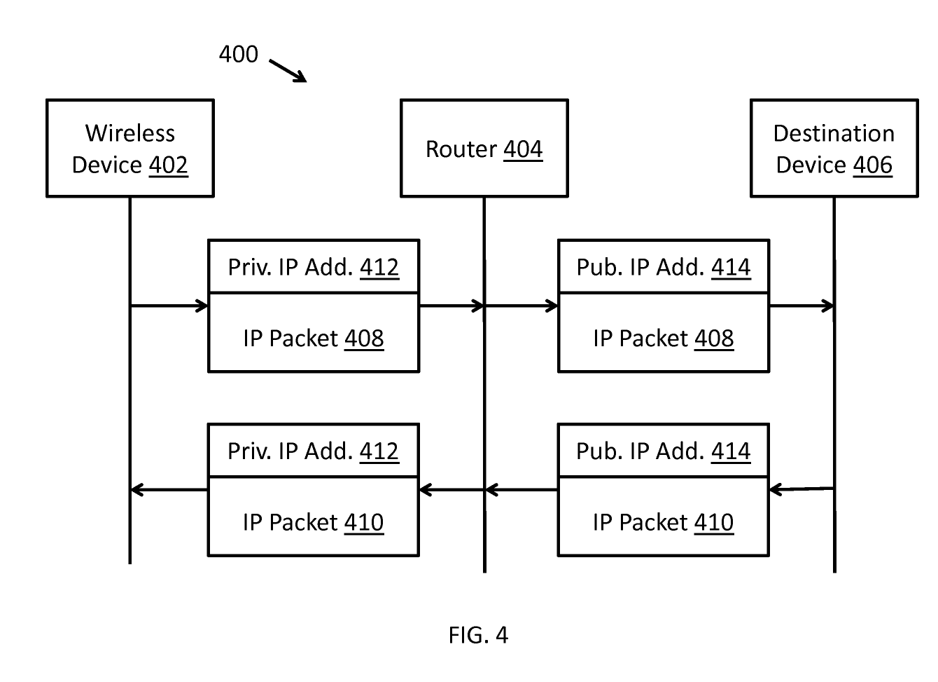

In some embodiments, the router can perform the IP address translation in the IP header of the packet. Performing the change in the header can leave the subscriber payload unaffected by the address translation. FIG. 4 illustrates a sequence 400 for IP address translation, according to some embodiments. The sequence includes wireless device 402, router 404 and destination device 406. Wireless device transmits packet 408 to destination device 406, and destination device 406 transmits packet 410 to wireless device 402.

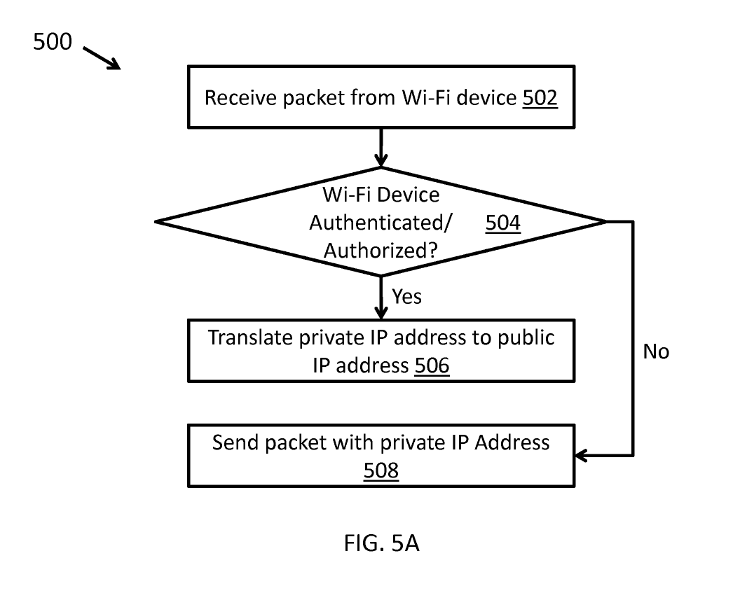

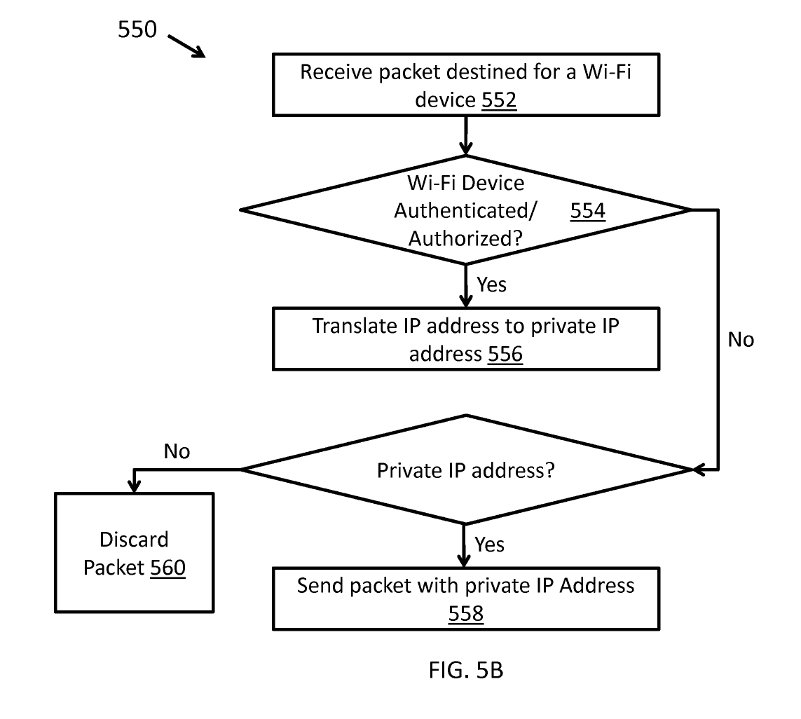

FIG. 5A illustrates a computerized method 500 for translating an IP address for IP address allocation, according to some embodiments. Referring to FIGS. 4 and 5A, at step 502 the router 404 receives a packet 408 from Wi-Fi device 402. The router inspects the packet header of packet 408 and identifies the private IP address 412 that was assigned to wireless device 402 (e.g., at step 304 of FIG. 3). At step 504 the router 404 determines whether device 402 was assigned a public IP address. If the router 404 identifies a public IP address assigned to the device 402 (e.g., in a database on the router 404), then the method proceeds to step 506 and the router 402 translates the private IP address 412 to the public IP address 414 assigned to the wireless device 402 (e.g., by manipulating just the IP packet 408 header). If the router 404 does not identify a public IP address assigned to the device 402, then the router 404 transmits the packet as-is without changing the private IP address 412 (not shown). For example, transmitting the packet as-is allows the service network to perform required actions for the device to allow the device full access to the network (e.g., resulting in assigning the device a public IP address). One of skill in the art can appreciate the IP packets are complex and include a number of different fields in the header. The IP address portion of the source (for packet 408) and for the destination (for packet 410) are only shown in these examples for simplicity.

FIG. 5B illustrates a computerized method 550 for translating an IP address for IP address allocation, according to some embodiments. Referring to FIGS. 4 and 5B, at step 552 the router 404 receives packet 410 destined for a Wi-Fi device 402 (e.g., via a modem such as the modem 104 in FIG. 1). At step 554 the router 404 determines whether the public IP address 414 in packet 410 corresponds to a wireless device associated with a private IP address. As explained above, a wireless device connected to the router 404 will be associated with a public IP address if it satisfies the requirements to be granted full access to the network. Therefore in some embodiments the router 404 can be configured to check incoming packets to determine whether the IP address needs to be translated back to a private IP address (e.g., since that is how the router is communicating with the device).

If the router 404 identifies a private IP address associated with the public IP address 414 (e.g., in a database on the router 404), then the method proceeds to step 556 and the router 404 translates the public IP address 414 to the private IP address 412 assigned to the wireless device 402 (e.g., by manipulating just the IP packet 410 header). If the router 404 does not identify a private IP address associated with assigned to the device 402, then the method proceeds to step 558 and the router 404 determines whether the IP address is a private IP address associated with a device (not shown in FIG. 4). From steps 556 and 558, the router 404 wirelessly transmits the packet (e.g., via the 802.11 protocol). Otherwise the method proceeds to step 560 and discards the packet.

The techniques described herein can be used to reduce public IP address use by migrant Wi-Fi subscribers. For example, as high as 80% of Wi-Fi subscribers can be migrant, so the allocation of private IP addresses for authentication related network connectivity (e.g., limited network connectivity) and for a limited duration can economize the use of public IP addresses for migrant subscribers. For example, since the public IP addresses are used only for the subscribers who intend to use the network (e.g., as shown through the device completing the activation steps required by the router and/or the network service provider), the techniques described herein can help avoid the denial of service to subscribers intending to use the network due to public IP address exhaustion that can occur if private IP addresses are not used before assigning public IP addresses. In some embodiments, the techniques described herein can help ensure that the network resources are allocated to the subscribers who intend to use network services thus enhancing the overall service provider's revenue stream, increasing the service availability of the network, and/or the like.

The techniques described herein provide advances to conventional network address translation (NAT). For example, NAT is generally used to translate a combination of a private IP address and a TCP/UDP port number to a public IP address and allocated TCP/UDP port numbers (e.g., for clients of a network). The techniques described herein can instead perform IP address translation only for devices that complete proper activation steps required to use the network. In some embodiments, a device must be authenticated and authorized (e.g., by the router and/or by the network service provider) before they are assigned a public IP address, and therefore a device must be authenticated and authorized before being granted access to the full range of services provided by the network service provider.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions. In addition, the phrase “based on” does not imply exclusiveness—for example, if X is based on A, X can also be based on B, C, and/or D, . . . .

What is claimed is:

1. A computerized method for allocating internet protocol (IP) addresses to devices in a manner that avoids assigning a public IP address to a device if the device is not first activated to use services provided by the network, comprising:
allocating, by a computing device, a private IP network address to a device, wherein the private IP network address:
is only valid for a predetermined period; and
only allows the device to activate itself with the network instead of providing the device full access to the network; and
monitoring, by the computing device, the device during the predetermined period so that:
if the device is activated to use the network during the predetermined period, the computing device assigns a public IP address to the device so that the device can access a full set of services provided by the network; or
if the device is not activated to use the network during the predetermined period, the private IP address allocated to the device is reclaimed by the computing device so that the private IP address is no longer allocated to the device and can therefore be allocated to other devices.

2. The computerized method of claim 1, further comprising:
receiving data indicative of the device being activated to use the network from a network service provider of the network; and
allocating a public IP address to the device so that the device can access the full set of services provided by the network.

3. The computerized method of claim 2, wherein receiving the data comprises receiving data indicative that the device was authenticated to use the network and that the device was authorized to use the network.

4. The computerized method of claim 1, further comprising:
determining that the device was not activated to use the network during the predetermined period; and
reclaiming the private IP address allocated to the device so that the private IP address is no longer allocated to the device and can therefore be allocated to other devices.

5. The computerized method of claim 1, further comprising:
receiving a packet from the device;
determining that the device was activated to use the network and is associated with a public IP address; and
translating the private IP address in a header of the packet to a public IP address.

6. The computerized method of claim 1, further comprising:
receiving a packet from the device;
determining that the device is not yet activated to use the network; and
transmitting the packet without changing the private IP address in a header of the packet.

7. A computing system configured to allocate internet protocol (IP) addresses to devices in a manner that avoids assigning a public IP address to a device if the device is not first activated to use services provided by the network, comprising:
a database configured to store a set of private IP network addresses and a set of public IP network addresses, wherein each private IP network address from the set of private IP network addresses:
is only valid for a predetermined period; and
only allows the device to activate itself with the network instead of providing the device full access to the network; and
a processor in communication with the database, and configured to run a module stored in memory that is configured to cause the processor to:
allocate a private IP network address from the set of private IP network addresses to a device; and
monitor the device during the predetermined period so that:
if the device is activated to use the network during the predetermined period, the computing system assigns a public IP address from the set of public IP addresses to the device so that the device can access a full set of services provided by the network; or
if the device is not activated to use the network during the predetermined period, the private IP address allocated to the device is reclaimed by the computing system so that the private IP address is no longer allocated to the device and can therefore be allocated to other devices.

8. The computing system of claim 7, wherein the module stored in memory is configured to cause the processor to:
receive data indicative of the device being activated to use the network from a network service provider of the network; and
allocate a public IP address to the device so that the device can access the full set of services provided by the network.

9. The computing system of claim 8, wherein receiving the data comprises receiving data indicative that the device was authenticated to use the network and that the device was authorized to use the network.

10. The computing system of claim 7, wherein the module stored in memory is configured to cause the processor to:
determine that the device was not activated to use the network during the predetermined period; and
reclaim the private IP address allocated to the device so that the private IP address is no longer allocated to the device and can therefore be allocated to other devices.

11. The computing system of claim 7, wherein the module stored in memory is configured to cause the processor to:
receive a packet from the device;
determine that the device was activated to use the network and is associated with a public IP address; and
translate the private IP address in a header of the packet to a public IP address.

12. The computing system of claim 7, wherein the module stored in memory is configured to cause the processor to:
receive a packet from the device;
determine that the device is not yet activated to use the network; and
transmit the packet without changing the private IP address in a header of the packet.

13. A non-transitory computer readable medium having executable instructions operable to cause an apparatus to:
allocate a private IP network address to a device, wherein the private IP network address:
is only valid for a predetermined period; and
only allows the device to activate itself with the network instead of providing the device full access to the network; and
monitor the device during the predetermined period so that:
if the device is activated to use the network during the predetermined period, the apparatus assigns a public IP address to the device so that the device can access a full set of services provided by the network; or
if the device is not activated to use the network during the predetermined period, the private IP address allocated to the device is reclaimed by the apparatus so that the private IP address is no longer allocated to the device and can therefore be allocated to other devices.

14. The non-transitory computer readable medium of claim 13, wherein the executable instructions are operable to cause the apparatus to:
receive data indicative of the device being activated to use the network from a network service provider of the network; and
allocate a public IP address to the device so that the device can access the full set of services provided by the network.

15. The non-transitory computer readable medium of claim 14, wherein receiving the data comprises receiving data indicative that the device was authenticated to use the network and that the device was authorized to use the network.

16. The non-transitory computer readable medium of claim 13, wherein the executable instructions are operable to cause the apparatus to:
determine that the device was not activated to use the network during the predetermined period; and
reclaim the private IP address allocated to the device so that the private IP address is no longer allocated to the device and can therefore be allocated to other devices.

17. The non-transitory computer readable medium of claim 13, wherein the executable instructions are operable to cause the apparatus to:
receive a packet from the device;
determine that the device was activated to use the network and is associated with a public IP address; and
translate the private IP address in a header of the packet to a public IP address.

18. The non-transitory computer readable medium of claim 13, wherein the executable instructions are operable to cause the apparatus to:
receive a packet from the device;
determine that the device is not yet activated to use the network; and
transmit the packet without changing the private IP address in a header of the packet.
